(19) United States
(12) Patent Application Publication
(10) Pub. No.: US 2020/0402127 A1
(43) Pub. Date: Dec. 24, 2020

(54) DESIGN CREATION, DISTRIBUTION, AND PUBLISHING SYSTEM, PROCESS, AND METHOD OF USE

(71) Applicant: Timothy K. Stohlman, Dallas, TX (US)

(72) Inventor: Timothy K. Stohlman, Dallas, TX (US)

(21) Appl. No.: 16/907,133

(22) Filed: Jun. 19, 2020

Related U.S. Application Data
(60) Provisional application No. 62/863,976, filed on Jun. 20, 2019.

(51) Int. Cl. G06Q 30/06; G06F 8/20; G06F 16/25; G06Q 50/18; G06Q 20/12; G06Q 10/10; G06F 30/12; G06F 3/0482

(52) U.S. Cl. CPC G06Q 30/0621; G06F 8/20; G06F 16/252; G06Q 50/184; G06Q 20/1235; G06F 2113/12; G06Q 10/10; G06Q 30/0607; G06F 30/12; G06F 3/0482; G06Q 30/0641

(57) ABSTRACT

A design creation, distribution, and publishing system, process and method of use are presented. The design creation, distribution, and publishing system and methods of use are presented which allow a user to generate a plurality of clothing designs from a single template. The design creation, distribution, and publishing system and method of use presented may include a machine-readable media for electronic management for the creation, editing, publication, and distribution of the content created. The design creation, distribution, and publishing system and method of use disclosed herein presents an example for the management and creation of content.

### CROSS-REFERENCE TO RELATED APPLICATIONS

The present application claims priority to U.S. Provisional Patent Application No. 62/863,976 which was filed on Jun. 20, 2019, which is hereby incorporated by reference herein in its entirety, including any figures, tables, or drawings.

### FIELD OF THE DISCLOSURE

This disclosure relates to a design creation, distribution, and publishing system, process and method of use. More specifically and without limitation, this disclosure relates to a design creation system for creating multiple designs from a single template, and related methods of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright AutoScale. All rights reserved.

### BACKGROUND OF THE DISCLOSURE

Textile printing is the process of applying color to fabric in patterns and/or designs. Various methods and printing textiles and accomplishing related tasks exist in the art today. Today, major inkjet technology manufacturers can offer specialized products designed for direct printing on textiles, not only for sampling but also for bulk production.

An example of such bulk production is a printed textile. Often times, a printed textile bears a design, image or lettering on it. Various designs, images, and lettering can be printed on a textile today with any of the various printing methods.

The development of traditional designs, publications, and customized consumer products is often a challenging, complicated, laborious process. The process often involved many authors, editors, proofers, illustrators, artists, and other contributors. The laborious task of developing this content may include assembling a rough draft from the content of one or more contributors creations, managing edits made by editors, and relying on various proofers to review the works. Finally, the publication process takes time, attention, and labor.

For these reasons, content creators face numerous challenges in achieving these tasks. Especially when these tasks fall across geographic regions which may be globally. An editor in India may be working with an author in South America, while the author in South America is working with a publisher in the United States. In this way, authors, editors, proofers, illustrators, artists, and other contributors are faced with having to assimilate the contributions from each of these dispersed contributors. In some cases, different users may use different document format, which adds to the complications, in other cases, a contributor and/or user may not be familiar with the interface of the graphic design creator or may otherwise not be familiar with the inner workings of a program, leading to content creation problems.

Thus, publishers, producers, and users will face the challenge of creating each piece of content through this laborious process. This process is a manual process. As one of many examples, inserted here strictly to illustrate the difficulty in content generation, we take the example of creating a graphical t-shirt or textile. In the event a user desires to create a custom graphic t-shirt or textile, the process is tedious and requires a lot of attention of the user. In some cases, different users may use different formats (e.g., contributors may use a word processing format such as Microsoft Word® while a proofer may use Adobe's Portable Document Format or PDF (.pdf).) Therefore, publishers and other users are faced with the challenge of converting various formats and propagating changes in one format to all the different formats used by various contributors. This is a manual task which requires close attention so that errors aren't made. Thus, this is a laborious and tedious task. Publishers and/or other users also struggle to properly track and manage the various versions and revisions of the content. This becomes tricky and upsets communication and disrupts tracking problems in the content, and furthermore disrupts tracking resolution of any problems that arise during the process. Publishers and other users also rely almost entirely on manual proofing, which itself is a laborious process. These challenges and others are only exacerbated when the content is in the form of electronic content generation, such as new media types including animation, videos, and the like which would display the media to potential clients, purchasers, or licensees. This new type of content generation does not easily fit into the existing process or work with existing publishing tools. Below is an example which illustrates some of the difficulties.

The latest process for making graphic t-shirts or textiles, as an example, would be the following. Step 1: a user chooses a theme for the textile. This may sound like a simple first step but it often requires extensive communication and the hiring of a designer. Alternatively, a user finds a theme already created on the web or available to the public. Users may run into copyright or other legal issues if they find a theme or design which they did not create themselves. Finding an existing theme might be a challenge considering search terms and availability. The designer and/or other contributor would come up with a theme for the textile. The user would likely pay the designer for the creation of the theme. Both the creation of a theme can be expensive, as well as, paying for an existing theme. This process usually involves iterations, a communication process, multiple personnel, and perhaps technology struggles depending on if both users have access to microsoft word, adobe illustrator, or other various technology which communicates theme and can be used to handover the design themes from one person to another. Assuming the user has a theme and in a readable format, the user can move on to step 2.

Step 2 is to apply the theme to an actual textile. This may seem like an easy task at first but no two t-shirts appear to be the same. Textiles vary in size, shape, design, and they vary in type and color. The correct textile must first be imported with the proper dimensions into photoshop or another technology. The theme must then be tit and applied. This step alone may take a designer and/or an editor. A user may need to download photoshop or other commonly used creative service software suites. These suites usually come at a cost. Once downloaded, the user will likely run into issues with how the image of the theme or design is laid out. The design may be a single “layer” such that the user cannot customize the design or make any changes. Additionally, not all users are familiar with using creation studios such as photoshop or other creation technologies which would create acceptable formats for print-on-demand shops.

Step 3 involves taking the photoshop design and using a textile design maker to create a graphic textile. Most people don't have a textile design maker and even fewer are familiar with how the technology works. Even the simplest of these technologies that are available to the public have specific parameters and often result in error message due to color, font, size, file format, and more.

Step 4: assuming a textile design maker can be successfully used to generate a textile design, a user would then upload the design to a print-on-demand shop and/or other print shop. Assuming the print shop accepts the file format, and the print is successfully loaded, then it is possible a shirt will be made.

Step 5: at step 5, a user is finally able to promote their textile design with mockups. The next step may be hiring a model to wear the textile. Additionally, a gallery of advertising for the textile may need to be created showing the textile. In summary, the process for making your own textile or other content is a very complex endeavour as a user must consider a number of complex and laborious matters.

This example, as mentioned herein is strictly one example, the example is strictly for the purpose of discussing an existing process for creating a textile. The example may be applied to the creation of any customized textile, customized designs, customized design template and more. Furthermore, the above example produces a single design for a single textile. The problems, number of people required, costs of production, and intensity of labor only increase as a second design, third design, fourth design, and more are added to the task list.

Thus, it is a primary object of this disclosure to provide a design creation, distribution, and publishing system and method of use for creating multiple designs for a plurality of designs from one single design template.

### SUMMARY OF THE DISCLOSURE

A design creation, distribution, and publishing system and method of use is presented. The design creation, distribution, and publishing system and method of use presented may include a machine-readable media for electronic management for the creation, editing, publication, and distribution of the content created. The design creation, distribution, and publishing system and method of use disclosed herein presents an example for the management and creation of content.

In one example, the system includes a content management component configured to store portions of the electronic content work and to implement various versions and control of various versions of the electronic content. The electronic content may include a dataset as a source for creating designs from uploaded layers. Each creation having prefillable data in the table, so the system can generate a design based on that date.

Thus, it is a primary object of the disclosure to provide a design creation, distribution, and publishing system and method of use that creates multiple designs from a single design template.

Another object of the disclosure is to provide a design creation, distribution, and publishing system and method of use that integrates with e-commerce platforms.

Yet another object of the disclosure is to provide a design creation, distribution, and publishing system and method of use that allows users to scale an existing graphic design concept out to hundreds, or more, of different variations.

Another object of the disclosure is to provide a design creation, distribution, and publishing system and method of use that can dynamically modify components of a graphic design.

Yet another object of the disclosure is to provide a design creation, distribution, and publishing system and method of use that dynamically modifies components of a graphic design to allow it to adapt the coloring, imagery, and/or other needs of a user.

Another object of the disclosure is to provide a design creation, distribution, and publishing system and method of use that allows a user to input a graphic design in various parts and/or components.

Yet another object of the disclosure is to provide a design creation, distribution, and publishing system and method of use that allows a user to modify each part and/or component individually.

Another object of the disclosure is to provide a design creation, distribution, and publishing system and method of use that allows a user to tailor the design to the styling of a specific brand and/or line.

Yet another object of the disclosure is to provide a design creation, distribution, and publishing system and method of use that can take a single design concept as input and create hundreds, if not more, of different versions, each tailored to the needs of a particular brand and/or line.

Another object of the disclosure is to provide a design creation, distribution, and publishing system and method of use that can perform the functions herein and more with a single click of a mouse, once the component parts have been loaded.

Yet another object of the disclosure is to provide a design creation, distribution, and publishing system and method of use that can pull all graphic design information from a comprehensive single database.

Another object of the disclosure is to provide a design creation, distribution, and publishing system and method of use that provides a comprehensive database capable of containing a myriad of information including, but not limited to, styling, imagery, coloration, and other legal needs of a brand.

Yet another object of the disclosure is to provide a design creation, distribution, and publishing system and method of use that does not require a user to have intimate knowledge of the needs of a brand.

Another object of the disclosure is to provide a design creation, distribution, and publishing system and method of use that does not require a user to have graphic design knowledge.

Yet another object of the disclosure is to provide a design creation, distribution, and publishing system and method, of use that allows any input file to be automatically applied to any amount of properties configured within the database.

Another object of the disclosure is to provide a design creation, distribution, and publishing system and method of use that allows rapid assimilation of a new brand.

Yet another object of the disclosure is to provide a design creation, distribution, and publishing system and method of use that provides near instant use with any new design.

Another object of the disclosure is to provide a design creation, distribution, and publishing system and method of use that improves upon the state of the art.

Yet another object of the disclosure is to provide a design creation, distribution, and publishing system and method of use that is easy to use.

Another object of the disclosure is to provide a design creation, distribution, and publishing system and method of use that is quick and efficient.

Yet another object of the disclosure is to provide a design creation, distribution, and publishing system and method of use that is accurate.

Another object of the disclosure is to provide a design creation, distribution, and publishing system and method of use that can be widely used.

Yet another object of the disclosure is to provide a design creation, distribution, and publishing system and method of use that can be used in a variety of ways.

Another object of the disclosure is to provide a design creation, distribution, and publishing system and method of use that is robust.

Yet another object of the disclosure is to provide a design creation, distribution, and publishing system and method, of use that saves time for a user.

Another object of the disclosure is to provide a design creation, distribution, and publishing system and method of use that saves capital for a user.

Yet another object of the disclosure is to provide a design creation, distribution, and publishing system and method of use that is high quality.

These and other objects, features, or advantages of the present disclosure will become apparent from the specification and claims.

### BRIEF DESCRIPTION OF THE DRAWINGS

FIG. 1 is a diagram illustrating the design creation, distribution, and publishing system and method of use; the diagram illustrating a design creation system; the diagram illustrating the design creation system having a graphical user interface; the diagram illustrating the graphical user interface having, a home feature; the diagram illustrating the graphical user interface having an accounts feature; the diagram illustrating a plurality of tabs; the diagram illustrating a design tab; the diagram illustrating a design page; the diagram illustrating various design launch features;

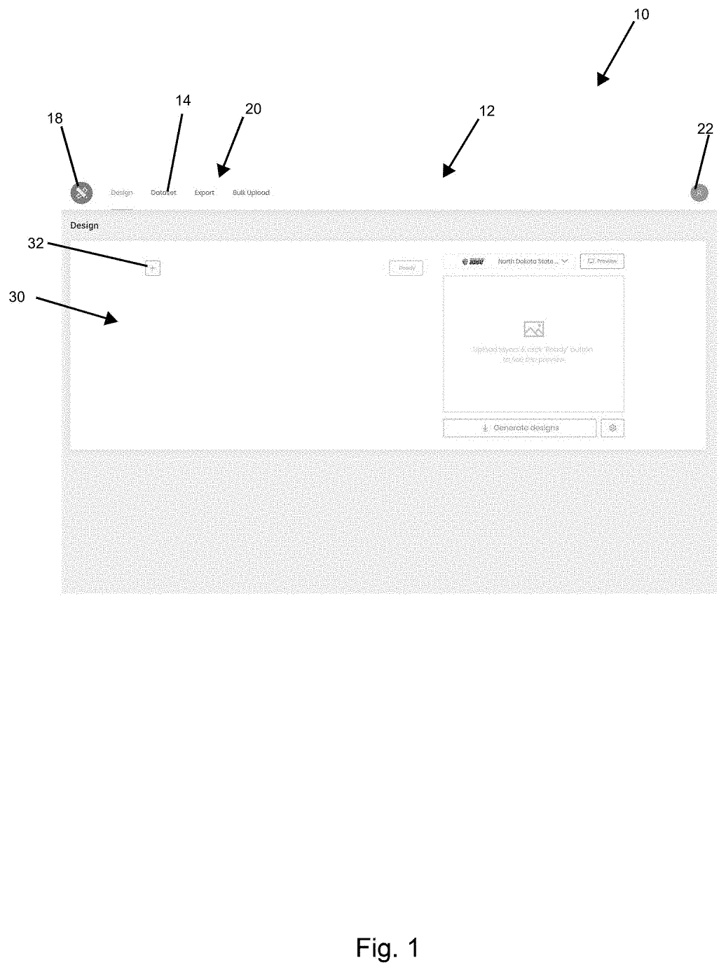

FIG. 2 is a diagram illustrating the design creation, distribution, and publishing system and method of use; the diagram illustrating a design creation system; the diagram illustrating the design creation system having a graphical user interface; the diagram illustrating the graphical user interface having, a home feature; the diagram illustrating the graphical user interface having an accounts feature; the diagram illustrating a plurality of tabs; the diagram illustrating a design tab; the diagram illustrating a dataset page; the diagram illustrating a plurality of features associated with design datasets;

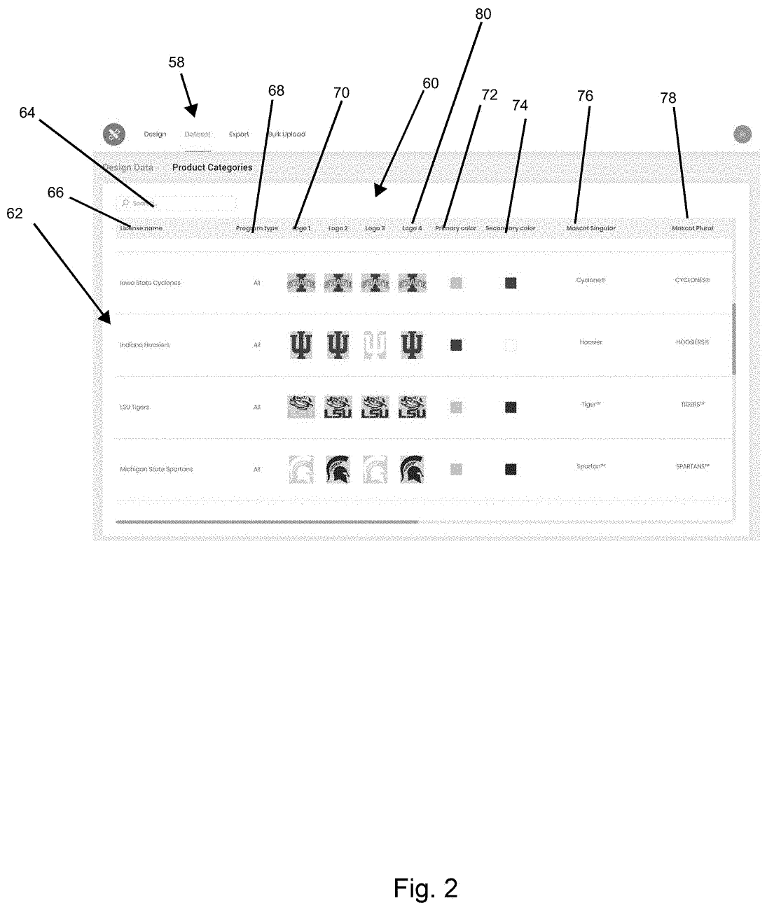

FIG. 3 is a diagram illustrating the design creation, distribution, and publishing system and method of use; the diagram illustrating a design creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating a products categories page; the diagram illustrating a plurality of features associated with product categories;

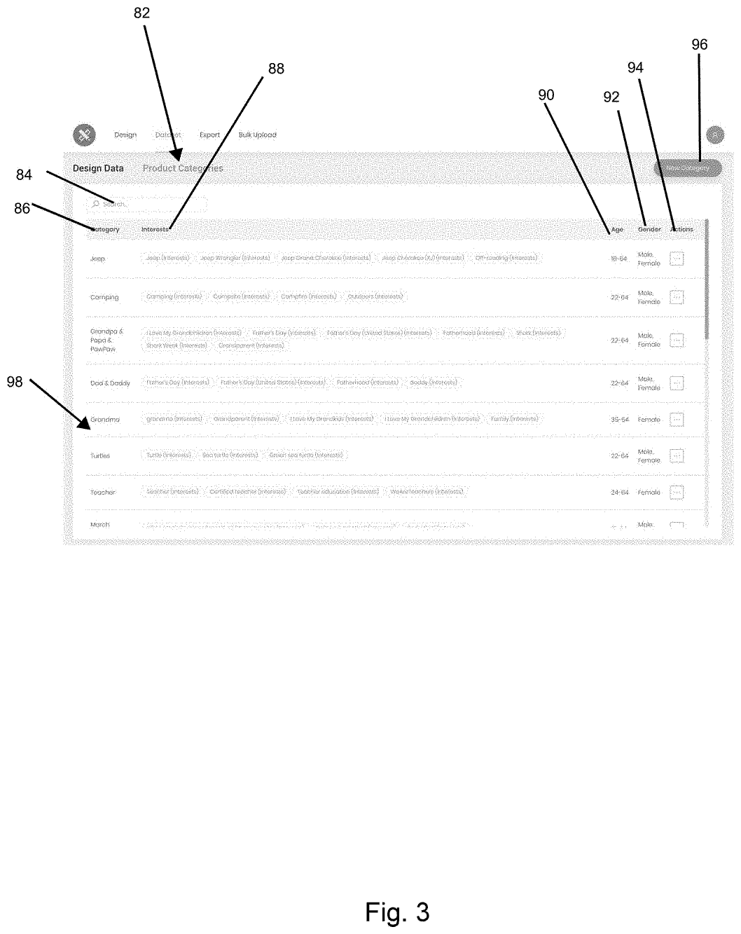

FIG. 4 is a diagram illustrating the design creation, distribution, and publishing system and method of use; the diagram illustrating a design creation system; the diagram illustrating the design creation system having a graphical user interface; the diagram illustrating the graphical user interface having, a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design;

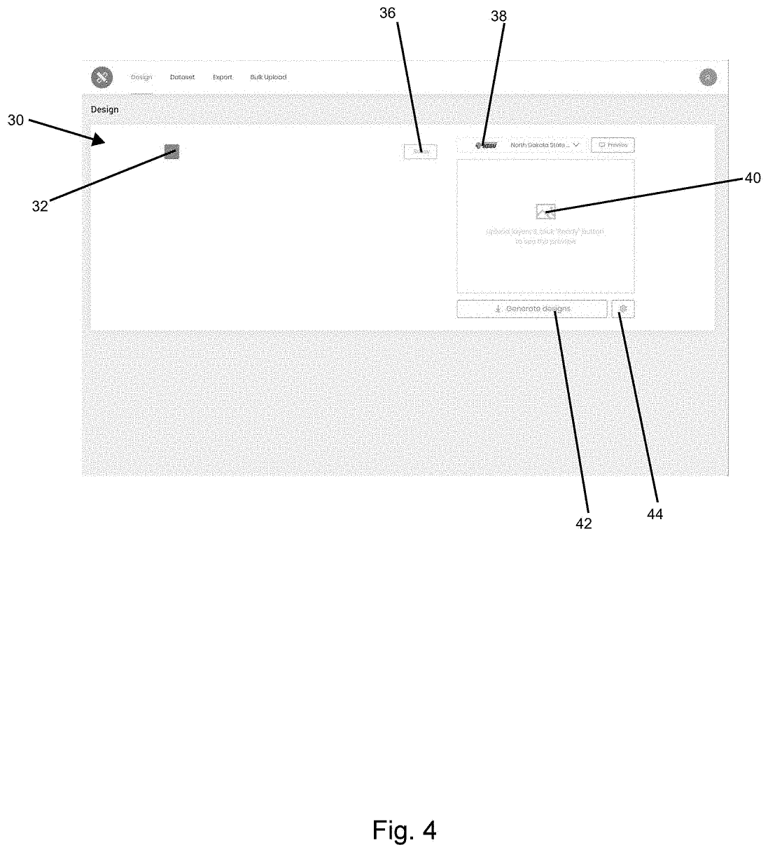

FIG. 5 is a diagram illustrating the design creation, distribution, and publishing system and method of use; the diagram illustrating a design creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers;

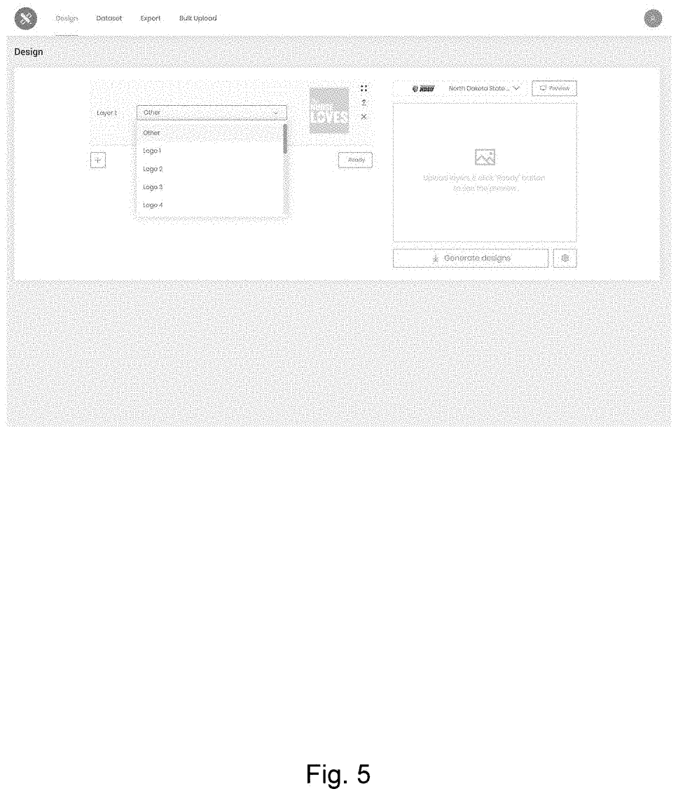

FIG. 6 is a diagram illustrating the design creation, distribution, and publishing system and method of use; the diagram illustrating a design creation system; the diagram illustrating the design creation system having a graphical user interface; the diagram illustrating the graphical user interface having, a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers;

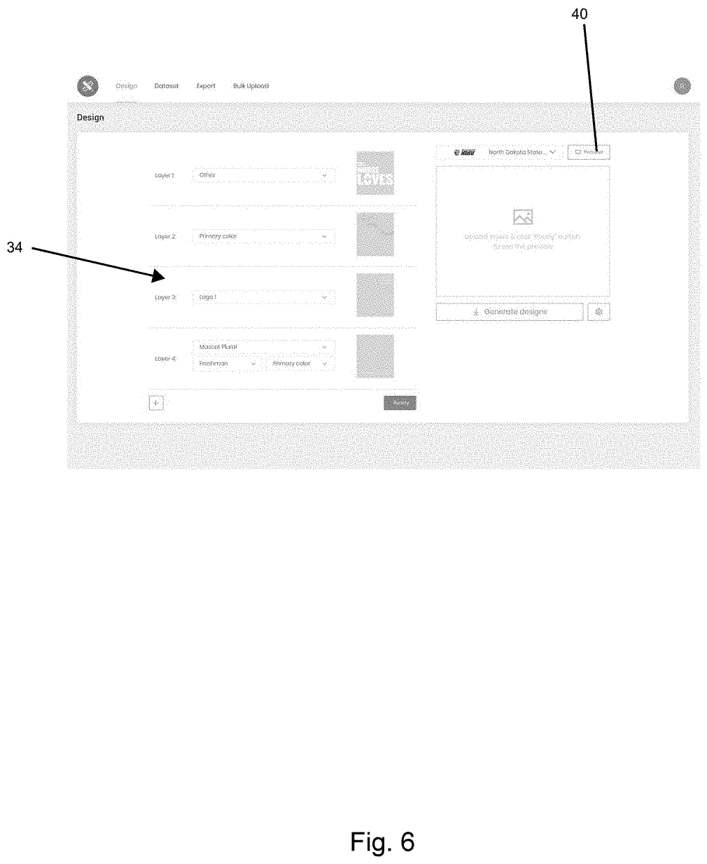

FIG. 7 is a diagram illustrating the design creation, distribution, and publishing system and method of use; the diagram illustrating a design creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers;

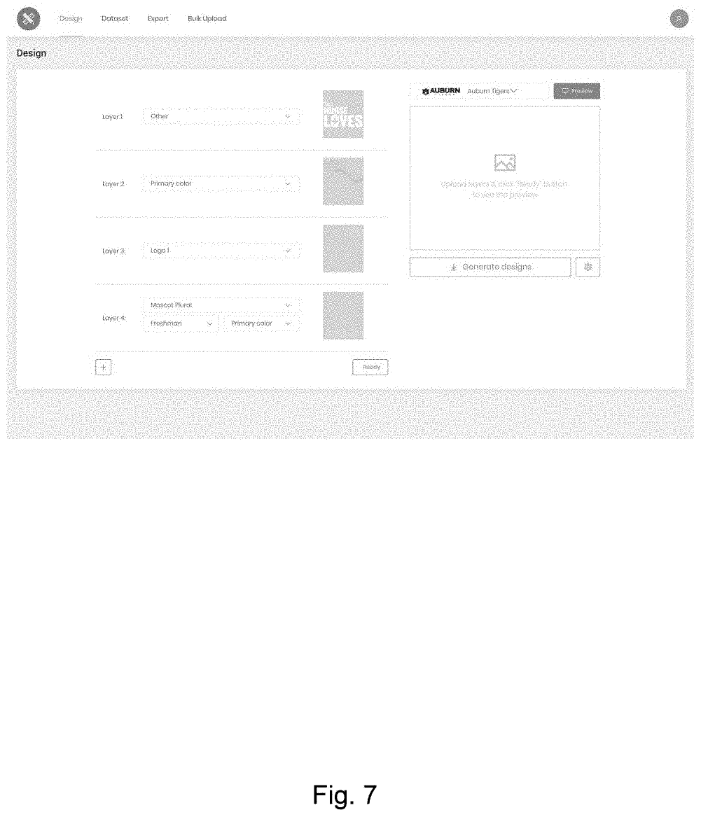

FIG. 8 is a diagram illustrating the design creation, distribution, and publishing system and method of use; the diagram illustrating a design creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers; the diagram illustrating a preview of the new design;

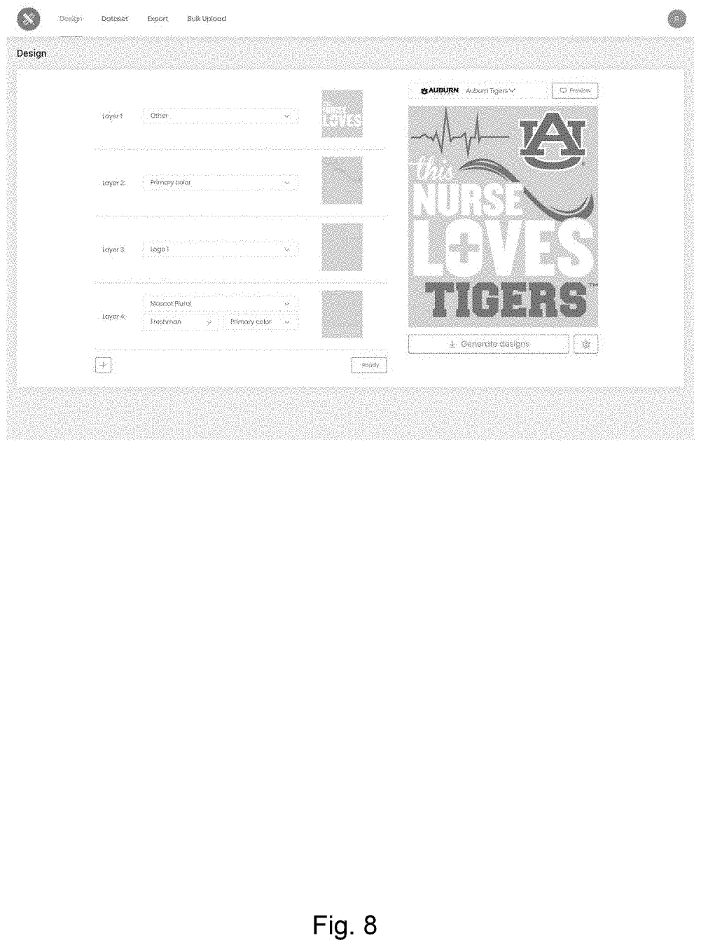

FIG. 9 is a diagram illustrating the design creation, distribution, and publishing system and method of use; the diagram illustrating a design creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers; the diagram illustrating a preview of the new design;

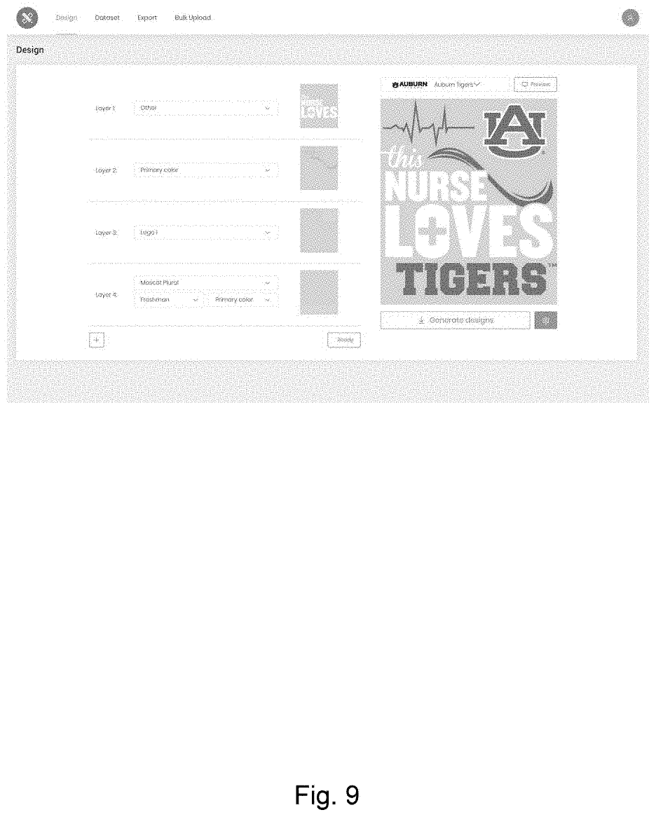

FIG. 10 is a diagram illustrating the design creation, distribution, and publishing system and method of use; the diagram illustrating a design, creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers; the diagram illustrating a preview of the new design; the diagram illustrating a plurality of features available for the customization of a design; the diagram illustrating various methods of use and creation of the system;

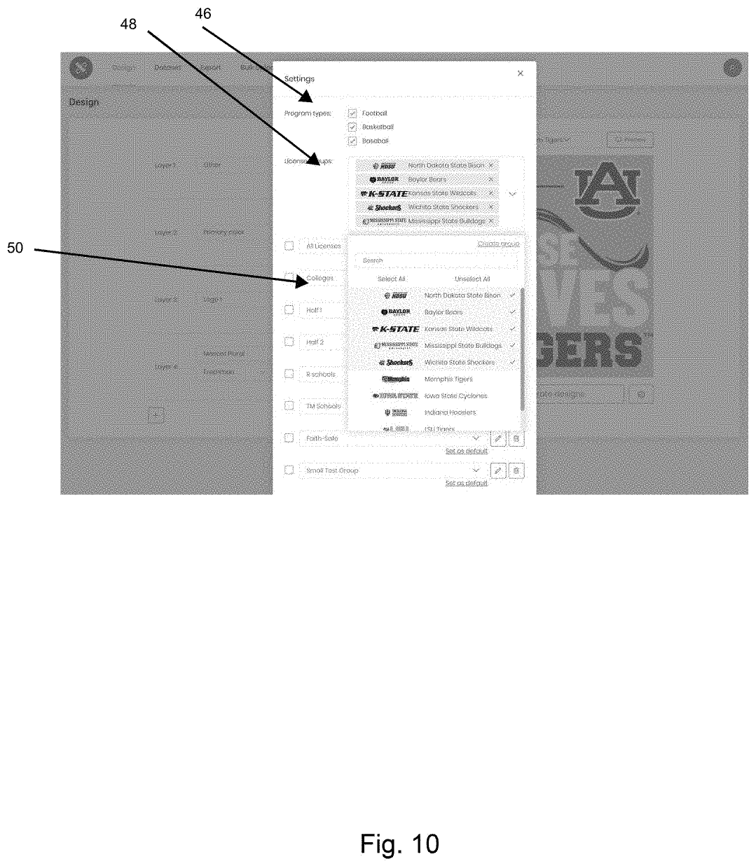

FIG. 11 is a diagram illustrating the design creation, distribution, and publishing system and method of use; the diagram illustrating a design creation system; the diagram illustrating the design creation system having a graphical user interface; the diagram illustrating, the graphical user interface having a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers; the diagram illustrating a preview of the new design; the diagram illustrating a plurality of features available for the customization of a design; the diagram illustrating various methods of use and creation of the system;

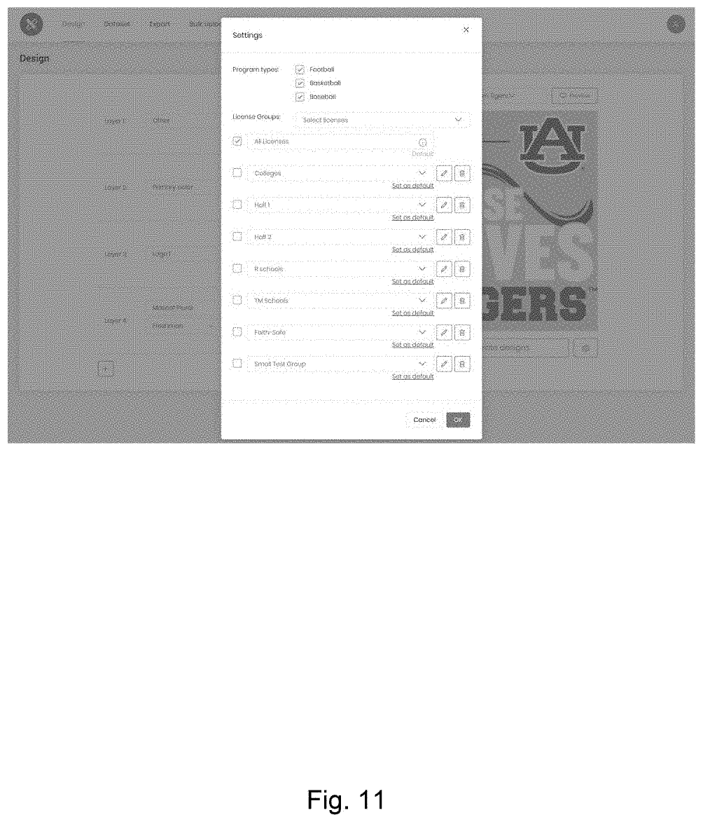

FIG. 12 is a diagram illustrating the design creation, distribution, and publishing system and method of use; the diagram illustrating a design creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating a design page; the diagram illustrating various design launch features; the diagram illustrating various methods of creating a new design; the diagram illustrating a method of creating a new design by use of layers; the diagram illustrating a preview of the new design; the diagram illustrating a plurality of features available for the customization of a design; the diagram illustrating various methods of use and creation of the system;

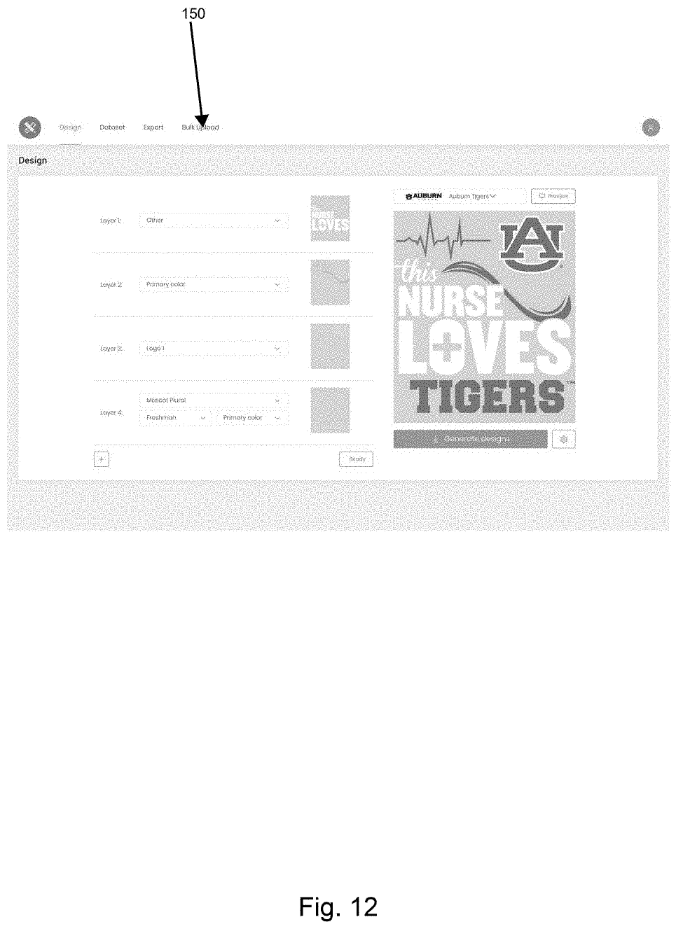

FIG. 13 is a diagram illustrating the design creation, distribution, and publishing system and method of use; the diagram illustrating a design creation system; the diagram illustrating the design creation system having a graphical user interface; the diagram illustrating the graphical user interface having a home feature; the diagram illustrating the graphical user interface having an accounts feature; the diagram illustrating a plurality of tabs; the diagram illustrating a design tab; the diagram illustrating an export page; the diagram illustrating various methods of exporting a design for use; the diagram illustrating a plurality of functions and features associated with a design;

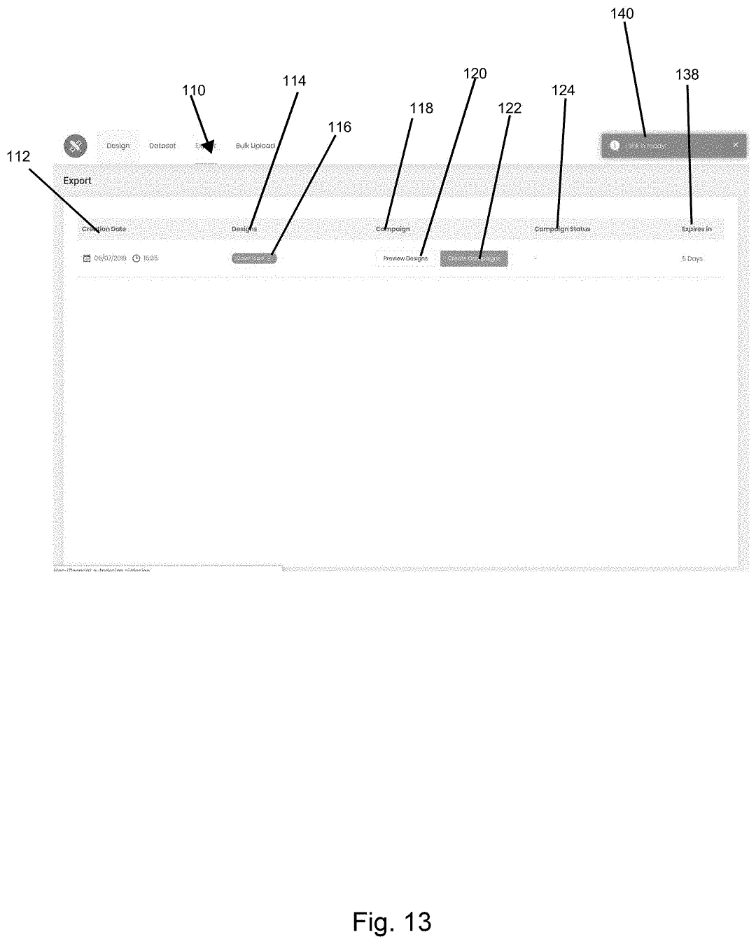

FIG. 14 is a diagram illustrating the design creation, distribution, and publishing system and method of use; the diagram illustrating a design creation system; the diagram illustrating the design creation system having a graphical user interface; the diagram illustrating, the graphical user interface having a home feature; the diagram illustrating the graphical user interface having an accounts feature; the diagram illustrating a plurality of tabs; the diagram illustrating a design tab; the diagram illustrating a design page: the diagram illustrating various design launch features; the diagram illustrating generating a plurality of designs through export that leads to multiple designs created from a single initial design;

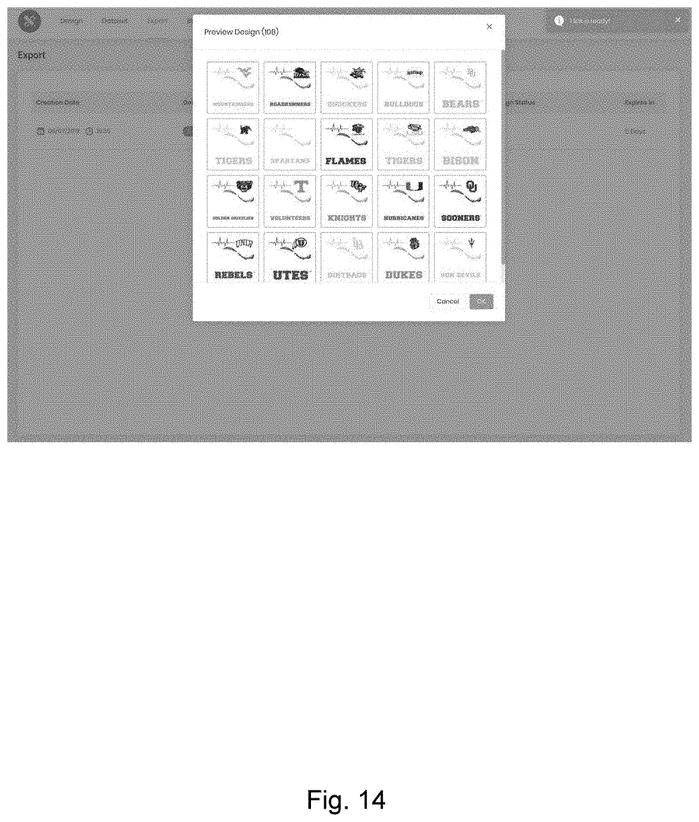

FIG. 15 is a diagram illustrating the design creation, distribution, and publishing system and method of use; the diagram illustrating a design creation system; the diagram illustrating the design creation system having a graphical user interface; the diagram illustrating the graphical user interface having, a home feature; the diagram illustrating the graphical user interface having an accounts feature; the diagram illustrating a plurality of tabs; the diagram illustrating a design tab; the diagram illustrating a product creation page; the diagram illustrating various product creation; the diagrams illustrating a plurality of methods for creation of a plurality of products from a single design; the diagram illustrating a plurality of methods for creation of a plurality of products from multiple designs;

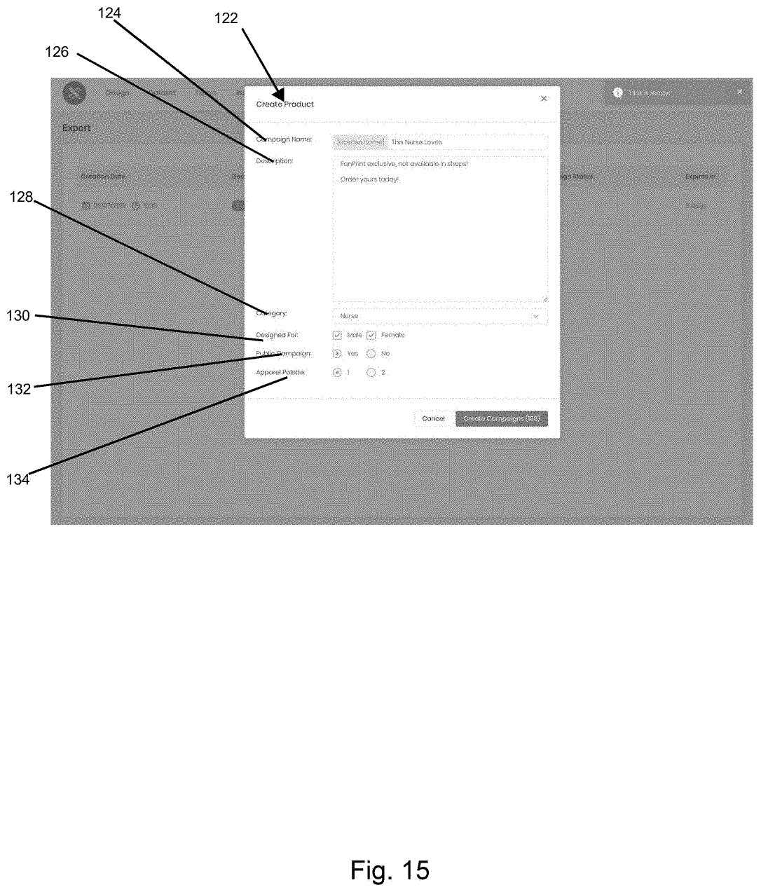

FIG. 16 is a diagram illustrating the design creation, distribution, and publishing system and method of use; the diagram illustrating a design creation system; the diagram illustrating the publishing and sale system having a graphical user interface; the diagram illustrating the graphical user interface having a home feature; the diagram illustrating the graphical user interface having an accounts feature; the diagram illustrating a plurality of tabs; the diagram illustrating a products tab; the diagram illustrating a management page for products; the diagram illustrating various sales and management methods;

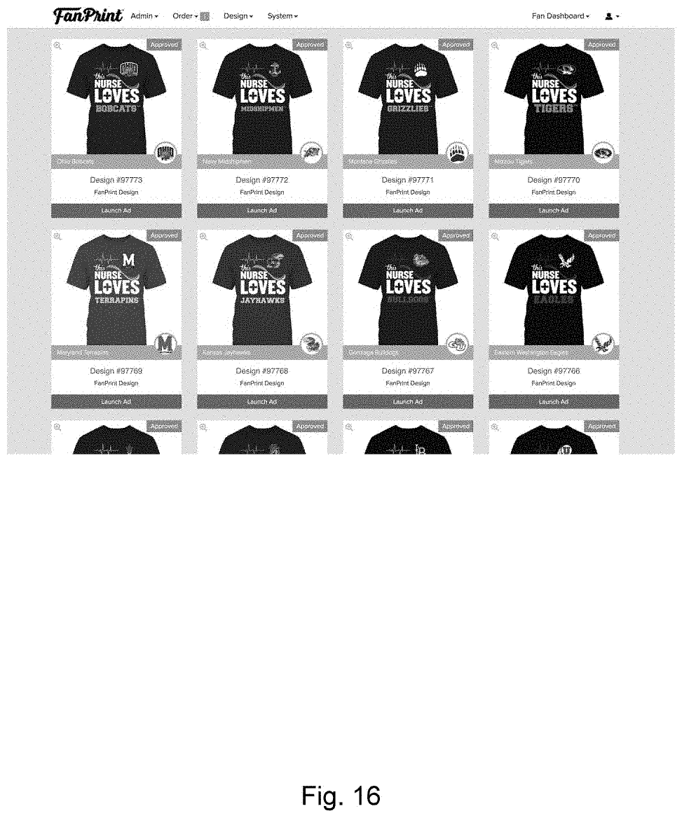

FIG. 17 is a diagram illustrating the design creation, distribution, and publishing system and method of use; the diagram illustrating the design and product scaling and launch; the diagram illustrating designer creation steps; the diagram illustrating creation of multiple versions of designs being created from a single design; the diagram illustrating creation of design campaigns.

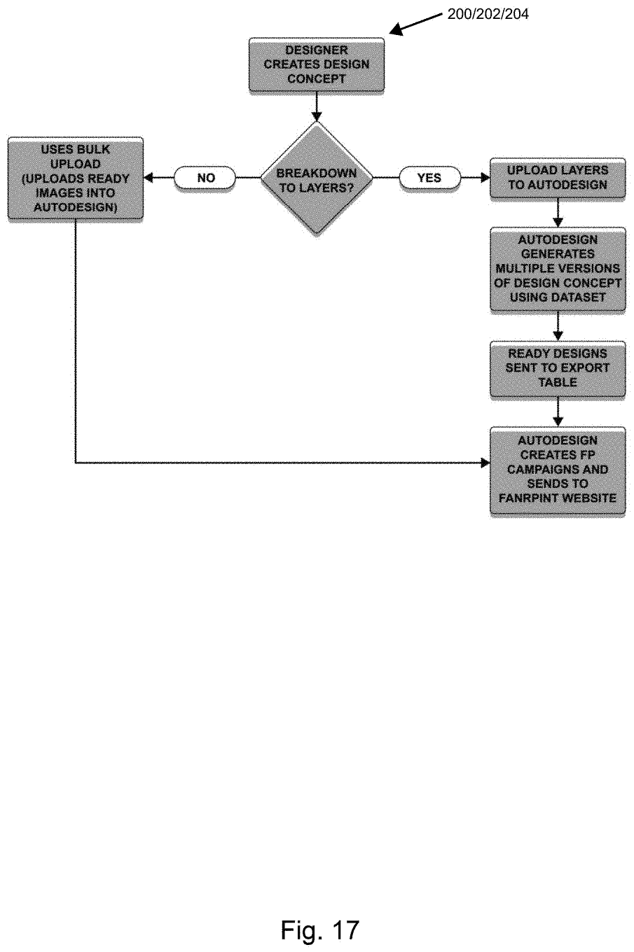

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Design system 10 may be formed of any suitable size, shape, and design and is configured to increase the convenience for retail, customers using the embodiments, herein. System 10 is configured to integrate with e-commerce platforms to allow users to scale an existing graphic design concept out to hundreds, or even more, of different variations by dynamically modifying components of the graphic design to allow it to adapt to the coloring, imagery, and other needs of each different user. By allowing a user to input a graphic design in its component parts, system 10 is able to modify each component part individually, tailoring it to the styling of the user. In this way, system 10 can take a single design concept as input and create hundreds, or more, of different versions, each tailored to the needs of the user, in a matter of minutes, or even less.

Embodiments of the present disclosure include systems and methods that automatically pull all of its graphic design information from a comprehensive database containing a myriad of information about the styling, imagery, coloration, and other legal needs of each brand. Furthermore, system 10, for the first time, allows a user with no graphic design knowledge, to complete the process. In other words, a user can generate thousands of designs catering to a specific brand need without having an intimate knowledge of the needs of the brand. Furthermore, system 10 allows any input file to be automatically applied to any amount of properties configured in a database. New users can be added with a minimal amount of configuration. In other words, new users, who have very specific rules and desires can be added to system 10, system 10 configuring and learning needs of each new property of the new user. This rapid assimilation of the new user provides for instant use with any new design file.

System:

With reference to the figures, a design creation, distribution, and publishing system 10 and method of use is presented (hereafter known as “design system” or simply “system”). Design system 10 is formed of any suitable size, shape and design. In the arrangement shown, as one example, design system 10, which may comprise remote servers, databases, application servers, application databases, product databases, mobile applications, and/or computers that fulfill the functions disclosed herein, also includes, in the embodiment depicted, a graphical user interface 12, a database 14, a plurality of datasets (a plurality of licenses) 16, a home screen 18, and a plurality of tabs 20. Additionally, system 10 may also include an account 22, among other components.

In the arrangement shown, as one example, system 10 comprises remote servers, databases, and/or computers that fulfill the functions disclosed and, described herein. In the embodiment depicted, system 10 comprises an application server 200. Application server 200 comprises one or more computer systems adapted to transmit and receive data regarding selected datasets related to various users and/or datasets related to multiple users. Application server 200 is adapted to query database with unique identification codes to retrieve a list of brand rules related to various users. Application server 200 may transmit product data related to layers and rules with respect to a single user and/or multiple users. Application server 200 is also adapted to query a product database 202. This query includes receiving and sending product identification codes and product data. Additionally, application server 200 may communicate with a mobile application 204, which is adapted to present the product information in a form conducive to being viewed on a mobile device and/or handheld device.

The appearance of the presentation of the product information and/or the process windows for creating hundreds of designs from a single template may be customized with data of particular relevance to the customer and the retail store at which the customer is most likely to be creating merchandise for. As one example, the appearance of windows and/or the process for creating hundreds of designs may be customized for pricing information, shipping location, and/or other information related merchandise and designs.

As one of ordinary skill in the art may understand, application server 200, product database 202, and other databases mentioned herein may be implemented in one or more servers. Furthermore, each may be on multiple servers to increase system efficiency, especially when handling large data gathering, following extended rules for brands and/or user and generating hundreds of designs at once from a single template. Additionally, multiple servers may have mirrored data to prevent data loss in case of disk failure and/or to decrease access and response times for database queries. In alternative embodiments, application server 200, and other database procedures may be carried out on computer-readable instructions and data stored on the customer's mobile computing device.

Graphical User Interface:

In the arrangement shown, as one example, system 10 includes a graphical user interface 12. Graphical user interface 12 is formed of any suitable size shape and design and is configured to guide a user through the design process including creating a design template, uploading information to a database as necessary and auto-generating designs from a single design template. Graphical user interface 12 is an exemplary method by which systems of the present disclosure may create hundreds, if not more, designs from a single design template. Using graphical, user interface 12, a user creates a single design with desired layers, which retrieve appropriate brand information, from the single creation, system 10 generates hundreds, or more designs.

In the arrangement shown, as one example, graphical user interface 12 includes a home page 18, a plurality of tabs 20, and may also include an account link 22, among other components. In this arrangement, as one example, a home 18 or home page 18, is generally the main page a user utilizes to navigate the website and/or graphical user interface. In addition, and in the arrangement shown, the home page 18 may also serve as a landing page, often times being the first page or a page by which a user lands after logging into their account 22. Additionally, a plurality of tabs 20 are also available to a user.

Tabs 20 are formed of any suitable size, shape, and design and are configured to give the user a way to navigate about system 10. In the arrangement shown, as one example, tabs 20 are arranged along the top of each various page and are designed to provide visual queues not only to what page the user is on but also to indicate to a user how far along they are in the process of creating hundreds of designs. The plurality of tabs 20 includes a design page 30, a design data page 60, and export page 110, among other optional pages and components.

Design Page: In the arrangement shown, as one example, graphical user interface 12 includes a design page 30. Design page 30 is formed of any suitable size, shape, and design and is configured as the main interaction page which enables a user to create a design template. In other words, the design page 30 is configured as a the main design template for a user to add layers to and arrange layers according to the design template a user desires to create. Additionally, in the design page 30, a user can select the desired brand. Additionally, in the design page 30, a user can preview the design template created. Additionally, the design page 30 can be used to generate designs and change settings. Said another way, the design page 30 serves as the design template creator for which hundreds of other designs are created.

In the arrangement shown, as one example, design page 30 includes an upload feature 32, a plurality of layers 34, a ready indicator 36, a brand selector feature 38, a preview feature 40, a generator 42, a settings feature 44, a program type 46, a group feature 48, and other selections 50, among other options, controls, and components.

Design Data Page: in the arrangement shown, as one example, graphical user interface 12 includes a dataset page 58 which includes a design data page 60. Design data page 60 is arranged in any size, shape, and design and is configured to provide a dataset 16 interface in which a user can interact with a dataset related to any brand 162. In this way, a user can interact with a dataset by adding to, editing, removing, viewing, searching, modifying and/or retrieving information from the dataset among other interactions. In the arrangement shown, as one example, the design data page 60 is a sub-page of dataset.

In the arrangement shown, as one example, design data page 60 may include a dataset 62, a search feature 64, a name feature 66, a type feature 68, a plurality of logos 70, a primary color feature 72, a secondary color feature 74, a mascot singular feature 76, a mascot plural feature 78, and other design data 80, among other options, controls, and components.

Product Categories Page: In the arrangement shown, as one example, graphical user interface 12 includes a dataset page 58 which includes a product categories page 82. Product categories page 82 is formed of any suitable size, shape, and design and is configured to identify and/or make connections to a particular dataset based on information provided. In other words, the product categories page 82 serves as a place where a user can interact with a dataset by adding to, editing, removing, viewing, searching, modifying and/or retrieving information from the dataset among other interactions. In the arrangement shown, as one example, the product categories page 82 is a sub-page of dataset.

In the arrangement shown, as one example, product categories page 82 includes a search feature 84, a category 86, a plurality of interests 88, an age category 90, a gender category 92, an actions category 94, a new category tool 96, and an other categories tool 98, among other options, controls, and components.

Export Page: In the arrangement shown, as one example, graphical user interface 12 includes an export page 110. Export page 110 is formed of any suitable size, shape, and design and is configured to enable a user to create design campaigns, preview design campaigns, download design campaigns, view recently created design templates, and more.

In the arrangement shown, as one example export page 110 includes a creation identifier 112, a designs feature 114, a download feature 116, a campaign feature 118, a previewer feature 120, a create campaign feature 122, a campaign name feature 124, a description feature 126, a category 128, a designed for identifier 130, a public campaign feature 132, an apparel pallette feature 134, a campaign status feature 136, an expiration notifier feature 138, and other notifications 140, among other options, controls, and components.

In addition to the above identified features, options, controls, and components, system 10 may also include a bulk upload feature 150, an order feature 152, additional databases 154, additional datasets 156, a dataset identifier 158, a plurality of data 160, a plurality of brands 162, a design template 164, a plurality of users 166, a plurality of user accounts 168, among other options, controls, and components.

In Operation/Method of Use:

As one example, design system 10 is a system, process, and method for automatically creating multiple designs from a variety of datasets from a single design template. In this way, the dataset page is used as a source for creating designs from uploaded layers. Each dataset is pre filled data in the database table, so the automated system can generate a design based on the dataset and/or datasets selected.

First, a user needs to upload logos and select colors for datasets in the dataset page. A user must upload this data unless the data was not already uploaded automatically, or unless the data was not already uploaded by another user. Once the dataset is uploaded and appears on the dataset page, a user moves on to the design page.

In the design page, a user will upload separate layers. A user will upload these layers unless the layers were already uploaded automatically, or unless the layers were not already uploaded by another user. A combination of the plurality of layers is what creates a final design. In the arrangement shown, as one example, the following layer options are available to a user: primary color layer, secondary color layer, logo 1 layer, logo 2 layer, shadow layer, wrinkle layer, black or white color layers, other design layers. However, other layers are hereby contemplated for use, including but not limited to, image layers, adjustment layers, fill layers, shape layers, type layers, filter layers, and more.

In the arrangement shown, as one example, a design may have a text layer which needs to colored with a primary color layer from the dataset. In this instance, a user uploads the primary color layer by selecting “primary color”. This indicates to the design system to retrieve the primary color data from the appropriate dataset. A user follows this same logic with each option. A user can add as many layers as a user would like. A user then selects the appropriate layer to be retrieved from the dataset. In the arrangement shown, as one example, a preview of the layer selected is displayed. In the arrangement shown, as one example, an “other layer” will appear with each design as is, meaning this “other layer” won't be colored, replaced with a text and/or logo, etc. In addition to adding layers and/or subtracting layers, as well as selecting the appropriate dataset to be retrieved for a layer, a user can “drag and drop” layers. In this way a user can put the layers in the desired sequence. Said another way, a user may change the sequence of which the layers will appear. In the arrangement shown, as one example, a user may change the sequence which the layers appear from the bottom to the top in a design.

Once a user has added and/or subtracted the desired number of layers, selected a dataset to be retrieved for each layer, and arranged the layers in a desired order, the final design may be created. In the arrangement shown, as one example, a final design preview is available. Once the user has evaluated the final design preview. The user indicates, by selecting a “READY” indicator, when all the layers are uploaded and ready. A final review of the data and the preview of the design is presented to a user before the user continues.

As a final step, as is shown in one example, a user clicks a “GENERATE” indicator to start the automated design system. Once “GENERATE” is clicked by a user, the system will start creating designs based, on the data the user has requested. Depending on the number of datasets and layers, the process could take some time to generate the many designs. In some instances, the process of design generate can be almost instant. In the arrangement shown, as one example, when the designs have been generated, a user can export the designs. Additionally, the various designs may be available in a zip file for the user to download. In this way, a user can generate hundreds of designs, or even more, with a single click.

It will be appreciated by those skilled in the art that other various modifications could be made to the device without parting from the spirit and scope of this disclosure. All such modifications and changes fall within the scope of the claims and are intended to be covered thereby.

What is claimed:

1. A design creation and distribution, comprising:
an application server;
a product database;
a database;
the database having a plurality of datasets;
the datasets having data;
a graphical user interface;
the graphical user interface having a design page feature;
the graphical user interface having a dataset page feature;
the graphical user interface having an export page feature;
wherein a user can generate a plurality of designs from a single design template.

2. The system of claim 1, further comprising:
wherein the user can distribute a plurality of designs from a single distribution template.

3. The system of claim 1, further comprising:
a plurality of layers;
wherein the plurality of layers form a design.

4. The system of claim 1, further comprising:
a plurality of layers;
wherein the plurality of layers form a design;
wherein the plurality of layers can be interchangeable such that a plurality of designs can be generated using the single design template.

5. The system of claim 1, further comprising:
a second design template;
a generate feature;
wherein the generate feature generates a plurality of designs from the second design template.

6. The system of claim 1, further comprising:
a content management system;
the content management system having a database associated with a plurality of licensing rules;
wherein the plurality of licensing rules are applied to the plurality of designs.

7. The system of claim 1, further comprising:
an e-commerce platform;
the e-commerce platform having a selling feature;
the e-commerce platform having an upload design feature;
a design distribution feature;
the design distribution feature having a dataset of designs;
wherein the design distribution feature automatically uploads the dataset of designs and launches a set of designs with a predetermined set of rules.

8. The system of claim 1, further comprising:
a variation feature;
the variation feature having a design manipulation rule set;
a content management system;
the content management system having a predetermined set of licensing rules;
a design;
the design having multiple layers;
wherein the design manipulation rule set of the variation feature automatically changes multiple layers of a design in accordance with the predetermined set of licensing rules.

9. The system of claim 1, further comprising:
a design generator;
a graphic design;
wherein the graphic design is created by the user through the graphical user interface;
the graphic design generated by the design template;
a predetermined set of graphic design rules;
a performance ranking system;
the performance ranking system having a plurality of parameters;
the performance ranking system having a predetermined set of rules for ranking a plurality of parameters;
wherein the design generator produces a plurality of dynamically modified designs based on the set of rules for ranking a plurality of parameters of the performance ranking system.

10. The system of claim 1, further comprising:
a plurality of brands;
the plurality of brands each having a set of licensing rules;
a design generator;
the design generator having a predetermined set of rules for each of the plurality of brands;
wherein the licensing rules are incorporated into the design generator so that designs can be generated which comply with the set of rules for each of the plurality of brands.

11. A design creation, distribution, and publishing system, comprising:
an application server;
a product database;
a database;
the database having a plurality of datasets;
the datasets having data;
a graphical user interface;
the graphical user interface having a design page feature;
the graphical user interface having a dataset page feature;
the graphical user interface having an export page feature;
wherein a user can generate a plurality of designs from a single design template;
an e-commerce integration feature;
the e-commerce integration feature having a set of parameters associated with a plurality of e-commerce websites.

12. The system of claim 11, further comprising:
wherein the e-commerce integration feature integrates the design creation system with each of a plurality of e-commerce websites using the set of parameters associated with the respective e-commerce website.

13. The system of claim 11, further comprising:
wherein the e-commerce integration feature integrates the distribution system with each of a plurality of e-commerce websites using the set of parameters associated with the respective e-commerce website.

14. The system of claim 11, further comprising:
wherein the e-commerce integration feature integrates the publishing system with each of a plurality of e-commerce websites using the set of parameters associated with the respective e-commerce website.

15. The system of claim 11, further comprising:
a bulk upload feature;
the bulk upload feature having a plurality of designs;
a plurality of e-commerce platforms;
the plurality of e-commerce platforms having a selectable group;
wherein the plurality of designs are uploaded to the selectable group of the plurality of e-commerce platforms.

16. The system of claim 11, further comprising:
a bulk upload feature;
the bulk upload feature having a plurality of rules:
a plurality of e-commerce platforms;
the plurality of e-commerce platforms having a selectable group;
wherein the plurality of rules are uploaded to the selectable group of the plurality of e-commerce platforms.

17. The system of claim 11, further comprising:
a hulk upload feature;
the bulk upload feature having a plurality of products;
a plurality of e-commerce platforms;
the plurality of e-commerce platforms having a selectable group;
wherein the plurality of products are uploaded to the selectable group of the plurality of e-commerce platforms.

18. A method of designing, creating, and publishing product designs, the method comprising the steps:
providing an application server;
providing a product database, the product database having a dataset having data;
providing, a graphical user interface;
interacting with the graphical user interface;
providing a set of licensing rules associated with a brand;
providing a set of layers;
integrating the set of licensing rules associated with a brand with the set of layers;
generating a plurality of designs based on a single design through integration of the set of licensing rules and the set of layers.

19. The method of claim 18, further comprising the steps:
providing, a bulk upload feature, the bulk upload feature having a plurality of designs;
integrating the bulk upload feature with a plurality of e-commerce platforms having a selectable group;
selecting a set of e-commerce platforms from the plurality of e-commerce platforms;
uploading a bulk set of designs to the plurality of e-commerce platforms with a single click.

20. The method of claim 18 further comprising the steps:
generating a plurality of product designs based on products generated from the plurality of designs created;
uploading the plurality of product designs across a selected set of e-commerce platforms.
